(19) United States
(12) Patent Application Publication
(10) Pub. No.: US 2014/0111822 A1
(43) Pub. Date: Apr. 24, 2014

(54) IMAGE FORMING APPARATUS CAPABLE OF CONTROLLING POWER SUPPLIES TO RESPECTIVE PARTS THEREOF, AND CONTROL METHOD AND STORAGE MEDIUM THEREFOR

(71) Applicant: CANON KABUSHIKI KAISHA, Tokyo (JP)

(72) Inventor: Hidenori HIGASHI, Kawasaki-shi (JP)

(73) Assignee: CANON KABUSHIKI KAISHA, Tokyo (JP)

(21) Appl. No.: 14/056,008

(22) Filed: Oct. 17, 2013

(30) Foreign Application Priority Data
Oct. 18, 2012 (JP) 2012-230945

(51) Int. Cl. H04N 1/00; G06K 15/00

(52) U.S. Cl. CPC H04N 1/00904; G06K 15/4055; H04N 1/00278
USPC 358/1.13

(57) ABSTRACT

An image forming apparatus capable of appropriately controlling power supplies to respective parts thereof when the apparatus is remotely started over a network. When receiving data from an external apparatus via the network, a controller of the image forming apparatus decides power supplied object, among a plurality of power supplied objects of the image forming apparatus, to which power supply is to be started at startup of the apparatus, and controls such that power supply to the decided power supplied object is started.

### BACKGROUND OF THE INVENTION

1. Field of the Invention

The present invention relates to an image forming apparatus capable of controlling power supplies to respective parts thereof, a control method therefor, and a storage medium storing a program for executing the control method.

2. Description of the Related Art

Some of recent image forming apparatuses have a function of network connection. In many offices, image forming apparatuses of this type (e.g. printers) are communicatable with a network so as to be capable of performing data processing while transmitting and receiving data and commands via the network to and from information processing apparatuses (such as personal computers) and/or to and from other image forming apparatuses.

Image forming apparatuses are known whose power can be turned on by a remote operation without the need for the user to go to the image forming apparatuses to turn on the power source thereof. For example, Japanese Laid-open Patent Publication No. 2009-253748 discloses a communication terminal device (such as a printer) that is capable of being activated from a remote place via a network. This communication terminal device is configured to transit from power saving mode to normal mode in response to a start packet transmitted from another terminal device.

Image forming apparatuses can be restored from power saving mode to normal mode not only in response to reception of a network packet as disclosed in Japanese Laid-open Patent Publication No. 2009-253748, but also in response to a power-saving release button of image forming apparatus being operated by the user.

When the image forming apparatus is restored from power saving mode to normal mode in response to a network packet, it is expected that the user is not near the image forming apparatus. Accordingly, the usability is less likely to be lowered, even if power supply to a user interface remains off so that the user interface remains inoperable at the time of restoration to the normal mode. By causing power supply to the user interface to remain off, power saving can be achieved. It is also preferable to cause power supply to the printer or to the scanner to remain off in order to attain the power saving effect.

On the other hand, when the image forming apparatus is restored from power saving mode to normal mode in response to the power-saving release button being operated by the user, it is expected that the user is near the image forming apparatus and will operate the user interface immediately after the restoration to the normal mode. To ensure the desired usability, it is necessary to immediately start power supply to the user interface so that the user interface is activated for operation.

However, the communication terminal device (image forming apparatus) disclosed in Japanese Laid-open Patent Publication No. 2009-253748 is configured, when restored from power saving mode to normal mode in response to a start packet transmitted from another terminal device, to simply turn on a switching element interposed between a power circuit and a main circuit block, thereby starting power supply to the main circuit block.

In other words, a cause of restoration of the communication terminal device to normal mode (i.e., a cause of startup of the device) other than reception of the start packet is not determined. It is therefore impossible to take into account whether the user is near the communication terminal device, so that it is only possible to perform uniform control regardless of whether the user is near the communication terminal device. At startup of the image forming apparatus, it is therefore impossible to perform optimum control for independently controlling power supplies to respective parts of the device according to the cause of startup of the device.

### SUMMARY OF THE INVENTION

The present invention provides an image forming apparatus capable of appropriately controlling power supplies to respective parts thereof when the apparatus is remotely started over a network, a control method for the image forming apparatus, and a storage medium storing a program for executing the control method.

According one aspect of this invention, there is provided an image forming apparatus including a plurality of power supplied objects and a power unit for controlling power supplies to the plurality of power supplied objects, the image forming apparatus being communicatable with an external apparatus via a network, comprising a reception unit configured to receive, from the external apparatus via the network, data that indicates on a per power supplied object basis a content of power supply control to be performed on the plurality of power supplied objects at startup of the image forming apparatus, a decision unit configured based on the data received by the reception unit to decide at least one power supplied object, among the plurality of power supplied objects, to which power supply is to be started at startup of the image forming apparatus, and a control unit configured to control the power unit such that power supply to the at least power supplied object decided by the decision unit is started at startup of the image forming apparatus.

With this invention, power supplies to respective parts of the image forming apparatus can be appropriately controlled when the image forming apparatus is remotely started over the network.

Further features of the present invention will become apparent from the following description of an exemplary embodiment with reference to the attached drawings.

### BRIEF DESCRIPTION OF THE DRAWINGS

FIG. 1 is a block diagram schematically showing a construction of an image forming apparatus according to one embodiment of this invention;

FIG. 2 is a block diagram schematically showing a construction of a controller of the image forming apparatus;

FIG. 3 is a block diagram showing a software structure of the controller;

FIG. 4 is a view showing transitions of the operation state of the image forming apparatus;

FIG. 5 is a block diagram showing energization on/off states of respective parts of the image forming apparatus when the apparatus is in a power-off state;

FIG. 6 is a block diagram showing energization on/off states of respective parts of the image forming apparatus when the apparatus is in a power saving state;

FIG. 7 is a block diagram showing energization on/off states of respective parts of the image forming apparatus when the apparatus is in a partially activated state;

FIG. 8A is a view showing a payload of a magic packet;

FIG. 8B is a view showing a payload of a magic packet that is used as data for the image forming apparatus;

FIG. 9A is a view showing a controlled object table that indicates a correspondence relation between octet numbers representing orders of octets in a 6-octet power control parameter contained in the payload of the magic packet of FIG. 8B and power supplied objects of the image forming apparatus;

FIG. 9B is a view showing a control content table that indicates a correspondence relation between numerical values of octets in the 6-octet power control parameter contained in the payload of the magic packet of FIG. 8B and contents of power supply control; and

FIG. 10 is a flowchart showing procedures of a starting process performed by a CPU of a main board of the controller.

### DESCRIPTION OF THE EMBODIMENTS

The present invention will now be described in detail below with reference to the drawings showing a preferred embodiment thereof.

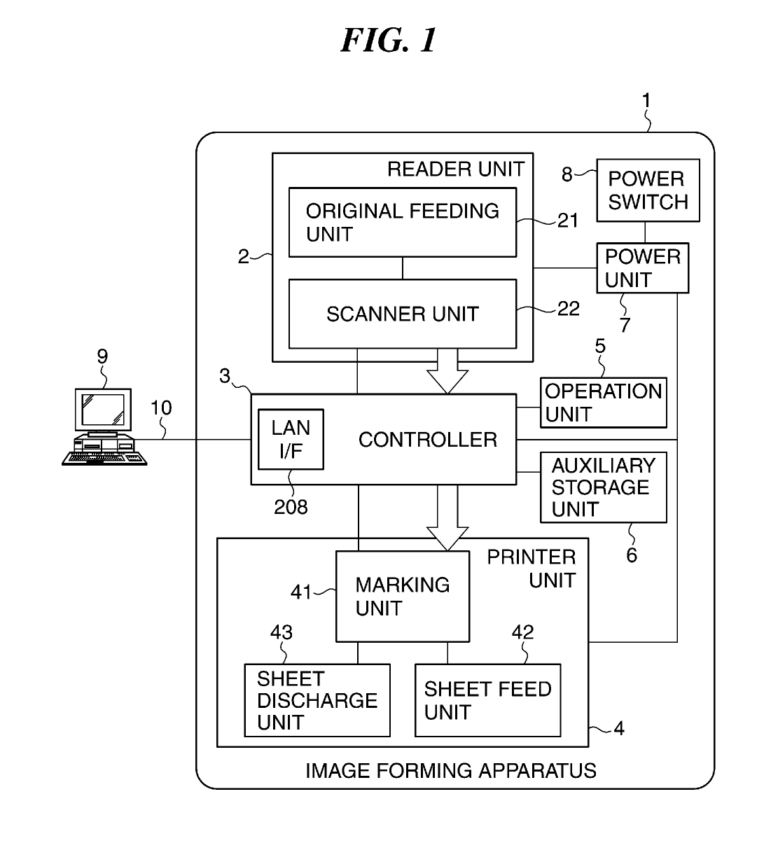

FIG. 1 schematically shows in block diagram a construction of an image forming apparatus according to one embodiment of this invention.

As shown in FIG. 1, the image forming apparatus (denoted by reference numeral 1) includes a reader unit 2, controller 3, printer unit 4, operation unit 5, auxiliary storage unit 6, power unit 7, and power switch 8. Hereinafter, the units 2 to 6 and their elements will be sometimes referred to as power supplied objects.

The controller 3 controls the entire image forming apparatus 1. The controller 3 has a LAN interface (LAN I/F) 208 communicatable with a computer 9 via a LAN 10. In other words, the image forming apparatus 1 is connected via the network (LAN 10) to the computer 9 serving as an external apparatus.

The reader unit 2 includes an original feeding unit 21 that stores originals and feeds originals one by one to a reading position, and a scanner unit 22 optically reads an image of an original fed to the reading position and converts the image into digital image data. The digital image data is transmitted to the controller 3.

The printer unit 4 includes a marking unit 41 for printing digital image data transmitted from the controller 3 on a sheet, a sheet feed unit 42 for storing sheets and for feeding sheets one by one to the marking unit 41, and a sheet discharge unit 43 for discharging a printed sheet.

The operation unit 5 is operable by the user to give an instruction to the image forming apparatus 1 and has a display device for displaying various information. The auxiliary storage unit 6 stores digital images, control programs, and the like. The power unit 7 controls power supplies to the power supplied objects such as the reader unit 2, the controller 3, and the printer unit 4. The power switch 8 is operable by the user to turn on/off the power source of the image forming apparatus 1. When the power switch 8 is on, i.e., when the apparatus power source is on, power is supplied from the apparatus power source to the power unit 7.

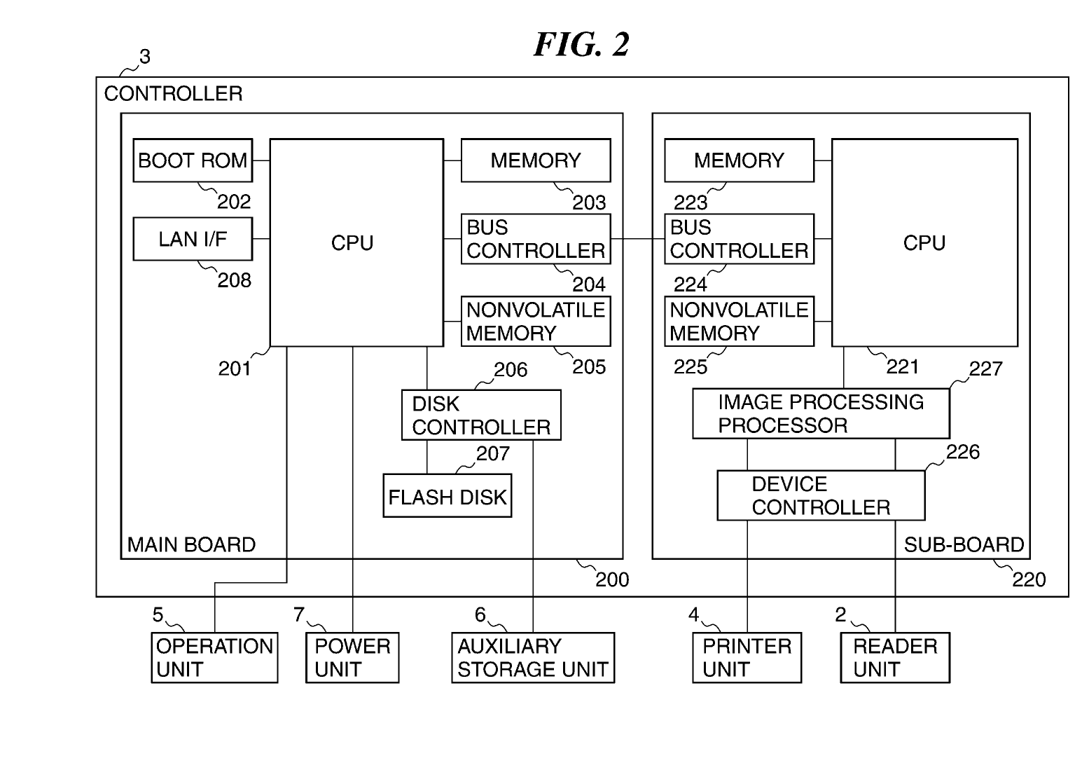

FIG. 2 schematically shows a construction of the controller 3 of the image forming apparatus 1.

As shown in FIG. 2, the controller 3 has a main board 200 and a sub-board 220.

The main board 200 includes a CPU 201, boot ROM 202, memory 203, bus controller 204, nonvolatile memory 205, disk controller 206, flash disk 207, and LAN interface 208. The main board 200 is connected with the operation unit 5, auxiliary storage unit 6, and power unit 7.

The CPU 201 controls the entire main board 200. The boot ROM 202 is stored with a boot program. The memory 203 is used as a work memory for the CPU 201.

The bus controller 204 has a bridge function with an external bus. The nonvolatile memory 205 can retain information stored therein even when power supply is shut off. The disk controller 206 controls storage devices, e.g., the auxiliary storage unit 6 and the flash disk 207.

The flash disk 207 is a relatively small-capacity storage device constituted by a semiconductor device such as SSD. The LAN interface 208 is communicatable with the LAN 10.

The sub-board 220 includes a CPU 221, memory 223, bus controller 224, nonvolatile memory 225, device controller 226, and image processing processor 227.

The CPU 221 controls the entire sub-board 220. The memory 223 is used as a work memory for the CPU 221. The bus controller 224 has a bridge function with an external bus and is communicatable with the bus controller 204 of the main board 200. The nonvolatile memory 225 can retain information stored therein even when power supply is shut off.

The image processing processor 227 performs real-time digital image processing. The device controller 226 controls the reader unit 2 and the printer unit 4.

Each of the CPUs 201, 221 is incorporated or connected with a chipset, bus bridge, clock generator, etc. but an illustration and description thereof are omitted herein.

In the following, a description will be given of operation of the controller 3 of the image forming apparatus 1 at the time of copying an image.

When the user operates the operation unit 5 to give an instruction to copy an image, the CPU 201 of the main board 200 sends an image reading instruction to the reader unit 2 via the CPU 221 of the sub-board 220. The reader unit 2 optically scans a paper original to obtain digital image data and transmits the digital image data to the image processing processor 227 via the device controller 226. The digital image data transmitted from the reader unit 2 is transferred by DMA by the image processing processor 227 to the memory 223 via the CPU 221 and temporarily stored in the memory 223.

When all of or a predetermined amount of digital image data is temporarily stored in the memory 223, the CPU 201 gives an image output instruction to the printer unit 4 via the CPU 221. The CPU 221 notifies the image processing processor 227 of a storage location of the image data in the memory 223. The image data temporarily stored in the memory 223 is transmitted to the printer unit 4 via the image processing processor 227 and the device controller 226 according to a sync signal supplied from the printer unit 4, and is printed on a sheet by the printer unit 4.

In the case of multiple-set printing, the CPU 201 can cause the auxiliary storage unit 6 to store image data temporarily stored in the memory 223. When printing the second and subsequent sets, the CPU 201 can read the image data from the auxiliary storage unit 6 and can transmit the image data to the printer unit 4.

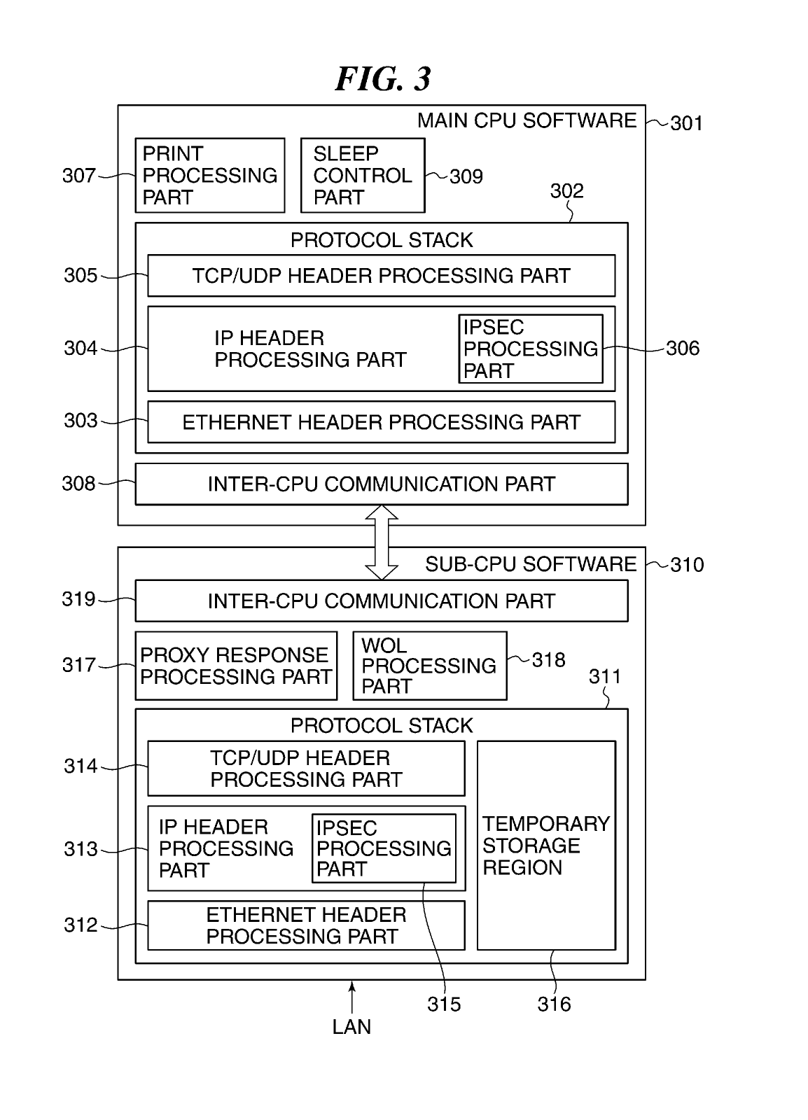

FIG. 3 schematically shows a software structure of the controller 3.

As shown in FIG. 3, the software structure of the controller 3 mainly has a main CPU software 301 that operates in a normal state and a sub-CPU software 310 that operates in a power saving state.

The main CPU software 301 includes a print processing part 307, a sleep control part 309, a protocol stack 302, and an inter-CPU communication part 308.

The print processing part 307 performs print-related processing. The sleep control part 309 operates on the CPU 201 of the main board 200 and controls e.g. a transition from the normal state where power is supplied to the main board 200 to the power saving state where reduced power is supplied to the main board 200.

The protocol stack 302 includes an Ethernet (registered trademark) header processing part 303, an IP header processing part 304 that includes an IPSEC processing part 306, and a TCP/UDP header processing part 305. The protocol stack 302 performs header processing according to protocol.

The IPSEC processing part 306 operates on a layer of the IP header processing part 304 and performs e.g. IPSEC negotiation processing, IPSEC processing on a network packet to be transmitted or received, and SA (security association) management required for the IPSEC processing.

The inter-CPU communication part 308 that operates on the CPU 201 performs data transmission/reception via the bus controller 204 to and from software that runs on a CPU (not shown) of the LAN interface 208.

The sub-CPU software 310 includes an inter-CPU communication part 319, a protocol stack 311, a proxy response processing part 317, and a WOL (Wake-on-Lan) processing part 318.

The inter-CPU communication part 319 that operates on the CPU of the LAN interface 208 performs data transmission/reception via the bus controller 204 to and from software that runs on the CPU 201 of the main board 200.

The protocol stack 311 includes an Ethernet (registered trademark) header processing part 312, an IP header processing part 313 that includes an IPSEC processing part 315, a TCP/UDP header processing part 314, and a temporary storage region 316. The protocol stack 311 performs header processing according to protocol.

The IPSEC processing part 315 that operates on the CPU of the LAN interface 208 performs IPSEC processing on a network packet to be transmitted or received and performs SA management. The temporary storage region 316 temporarily stores a received packet and SA information.

The proxy response processing part 317 that operates on the CPU of the LAN interface 208 determines whether or not a response to a received packet can be sent by the CPU of the LAN interface 208 without restoring the CPU 201 of the main board 200 to an operating state. Based on a result of the determination, the proxy response processing part 317 controls generation and transmission of a response packet.

The WOL processing part 318 determines whether or not the received packet has a pattern indicating that the CPU 201 of the main board 200 is to be restored to the operating state. Based on a result of the determination, the WOL processing part 318 performs a restoration processing to restore the CPU 201 to the operating state.

The sub-CPU software 310 classifies received packets into three categories of packets (i.e., a “packet to be discarded” category, a “packet to be transferred to the main CPU software 301” category, and a “packet to be proxy-responded” category).

The packet classified into the “packet to be discarded” category is a packet that can be ignored (i.e., to which no response is required) such as a packet not addressed to the corresponding image forming apparatus. The received packet of this category is discarded.

The packet classified into the “packet to be transferred to the main CPU software 301” category is a packet to be subjected to some processing that cannot be done solely by the LAN interface 208. When receiving such a packet, the proxy response processing part 317 (the CPU of the LAN interface 208) causes the image forming apparatus 1 to transit from the power saving state to the normal state, and transfers the received packet to the CPU 201 of the main board 200.

The packet classified into the “packet to be proxy-responded” category is a packet for which a proxy-response can be sent by the proxy response processing part 317 (the CPU of the LAN interface 208). When receiving such a packet, the proxy response processing part 317 transmits a response to the received packet. At that time, if the packet to be transmitted or received is an IPSEC packet, packet transmission/reception control is performed while utilizing the IPSEC processing part 315.

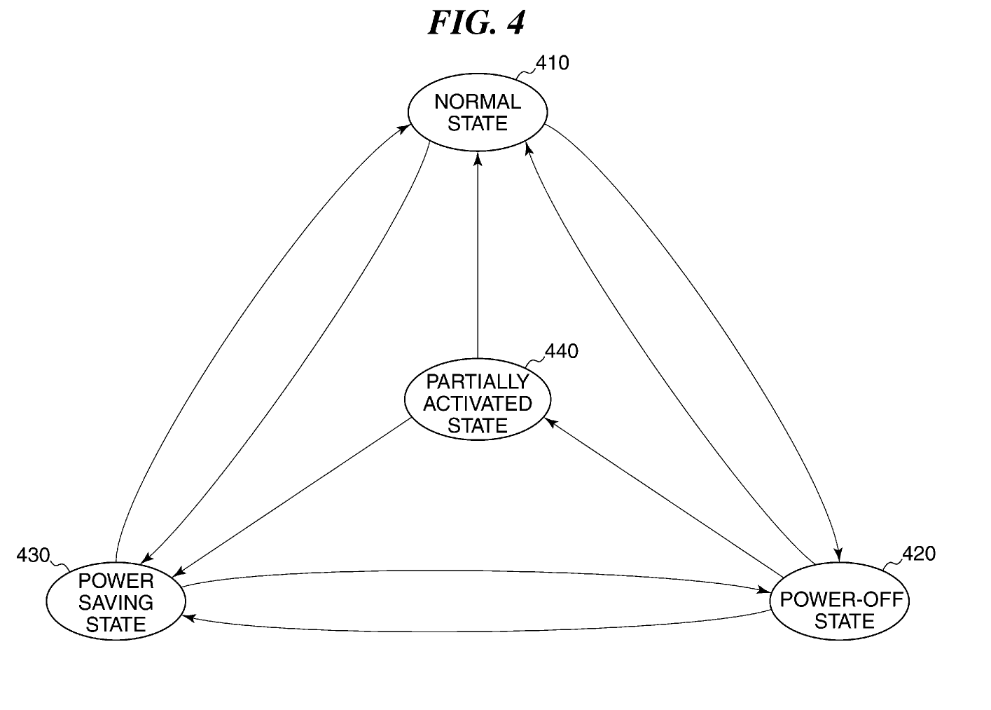

FIG. 4 shows transitions of the operation state of the image forming apparatus 1.

As shown in FIG. 4, the operation state of the image forming apparatus 1 transits among a normal state 410, power-off state 420, power saving state 430, and partially activated state 440.

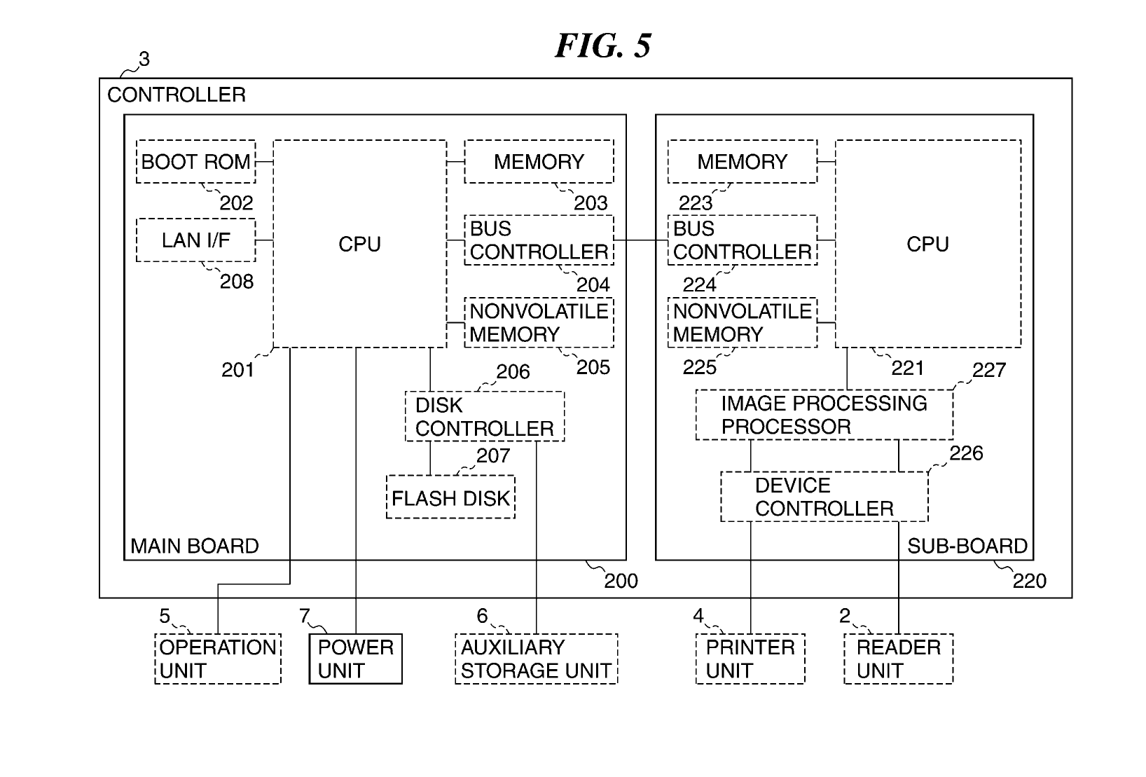

FIGS. 5 to 7 show energization on/off states of respective parts (power supplied objects) of the image forming apparatus 1 when the apparatus 1 is in power-off state 420, in power saving state 430, and in partially activated state 440, respectively. In FIGS. 5 to 7, power supplied objects of the image forming apparatus 1 that are not energized are each shown by a dotted-line block.

In the following, a description will be given of state transitions in the image forming apparatus 1 with reference to FIG. 4.

In the normal state 410 where power is supplied to all of the power supplied objects of the image forming apparatus 1, a transition event to the power saving state 430 (such as a user's operation for transition to power-saving, or a timer event) can sometimes occur. In that case, the image forming apparatus 1 transits from the normal state 410 to the power saving state 430.

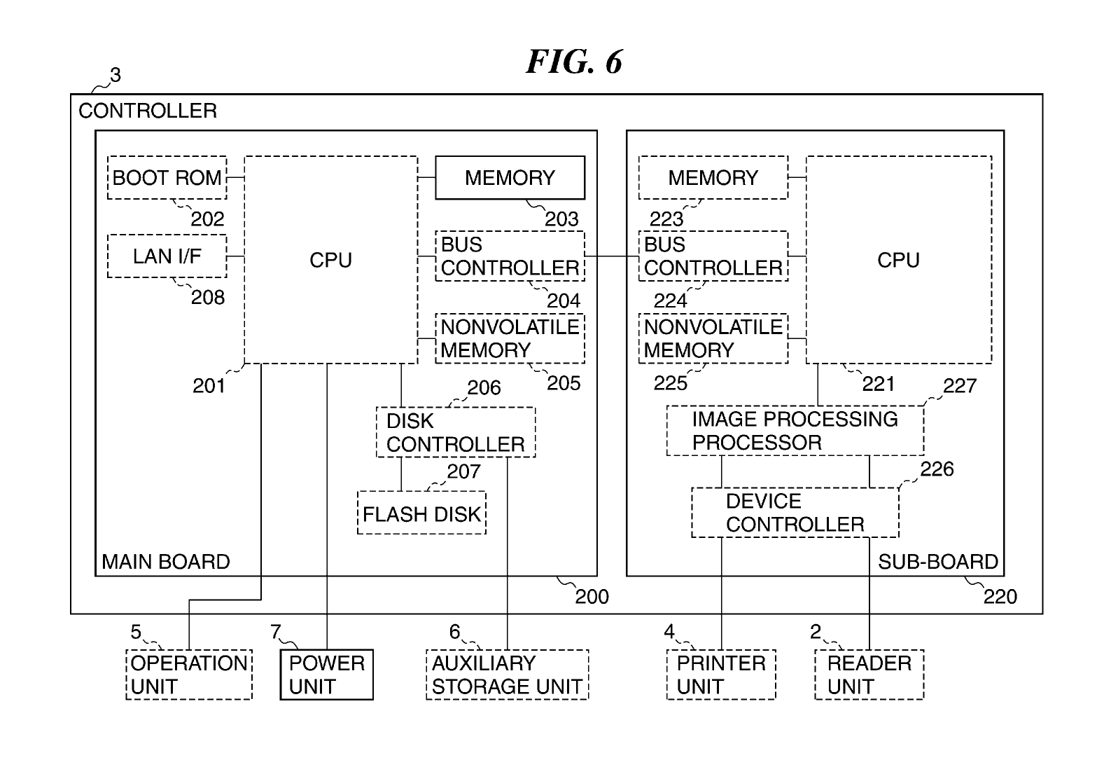

In the power saving state 430, power supplies to the power supplied objects other than to the memory 203 are shut off, as shown in FIG. 6, to reduce power consumption in the image forming apparatus 1, but reduced power is kept supplied to the LAN interface 208. Since power supply to the memory 203 is not shut off, the memory 203 remains energized, whereby contents in the memory 203 stored until the image forming apparatus 1 transits to the power saving state 430 are retained. The stored contents in the memory 203 can be referred to when the image forming apparatus 1 restores from the power saving state 430 to the normal state 410.

When a transition event to a normal state 410 (such as reception of a network packet, a user's operation for transition to normal state, or a timer event) occurs in the power saving state 430, the image forming apparatus 1 transits from the power saving state 430 to the normal state 410.

When a transition event to a power-off state 420 (such as a user's power-off operation or a remote power-off) occurs in a power saving state 430, the image forming apparatus 1 transits from the power saving state 430 to the power-off state 420 where power supplies to constituent elements of the image forming apparatus 1 other than the power unit 7 (i.e., power supplies to all of the power supplied objects) are shut off as shown in FIG. 5. It should be noted that reduced power is kept supplied to the LAN interface 208.

When a transition event to a normal state 410 (such as a user's power-on operation or a timer event) occurs in a power-off state 420, the image forming apparatus 1 transits from the power-off state 420 to the normal state 410.

When a transition event to a power-off state 420 (such as a user's power-off operation or a timer event) occurs in a normal state 410, the image forming apparatus 1 transits from the normal state 410 to the power-off state 420.

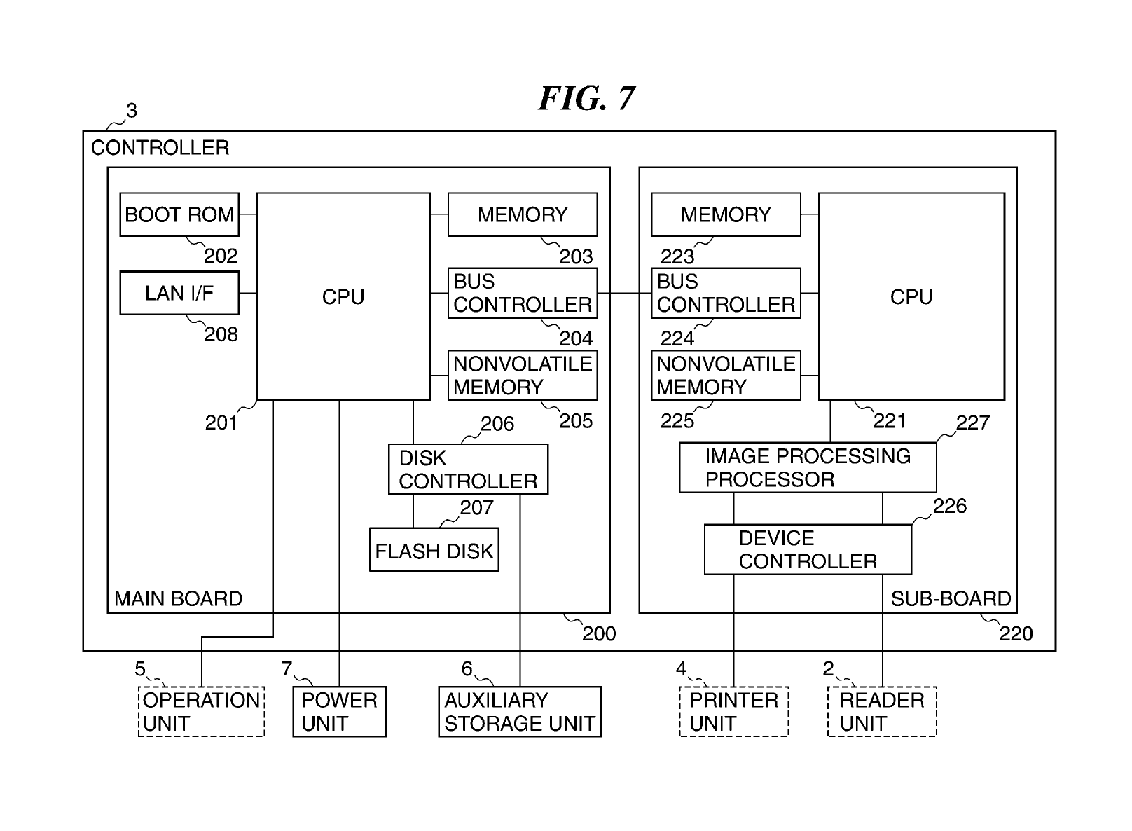

When a remote power-on is performed in a power-off state 420 over the network based on a magic packet (described later), the image forming apparatus 1 transits from the power-off state 420 to a partially activated state 440. In a case where the image forming apparatus 1 is activated or started in response to remote power-on, there is a high possibility that the user is not near the image forming apparatus 1 and there is few case that the image forming apparatus 1 is used by the user immediately after the startup of the apparatus. In that case, it is not preferable to supply the power to e.g. the reader unit 2 or to the printer unit 4 from the viewpoint of power saving. In the partially activated state 440, therefore, power supplies to the reader unit 2, printer unit 4, and operation unit 5 are shut off as shown in FIG. 7.

When a transition event (such as a key depression by the user or a setting of originals onto the original feeding unit 21) occurs in a partially activated state 440, the image forming apparatus 1 transits from the partially activated state 440 to the normal state 410.

Upon lapse of a predetermined time period without a user's operation and without a job reception from when the image forming apparatus 1 transits to the partially activated state 440 in response to a remote power-on, the image forming apparatus 1 transits from the partially activated state 440 to the power saving state 430.

As described above, the image forming apparatus 1 performs power supply control where power supplies to respective parts (power supplied objects) of the apparatus are on-off controlled according to the operation state of the apparatus.

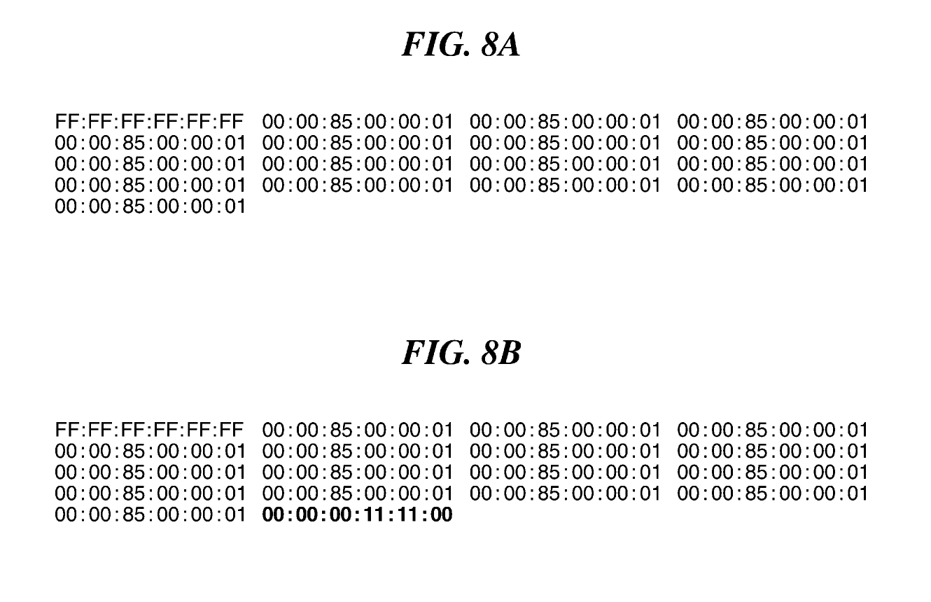

FIG. 8A shows a payload of a magic packet, and FIG. 8B shows a payload of a packet that is used as data for the image forming apparatus 1.

In FIG. 8A, the magic packet is a packet containing anywhere within its payload a broadcast MAC address FF:FF:FF:FF:FF:FF, followed by sixteen repetitions of a MAC address (00:00:85:00:00:01 in the example of FIG. 8A) of an apparatus to be started.

The payload of the magic packet shown in FIG. 8B is an extension of the payload of the magic packet of FIG. 8A, and used as the data for the image forming apparatus 1 in this embodiment. More specifically, the payload of the magic packet of FIG. 8B not only includes broadcast MAC address FF:FF:FF:FF:FF:FF and sixteen repetitions of the MAC address (e.g., 00:00:85:00:00:01) of the image forming apparatus 1, which are contained in the payload of the magic packet of FIG. 8A, but also includes a 6-octet power control parameter 00:00:00:11:11:00 that follows the sixteenth repetitions of the MAC address.

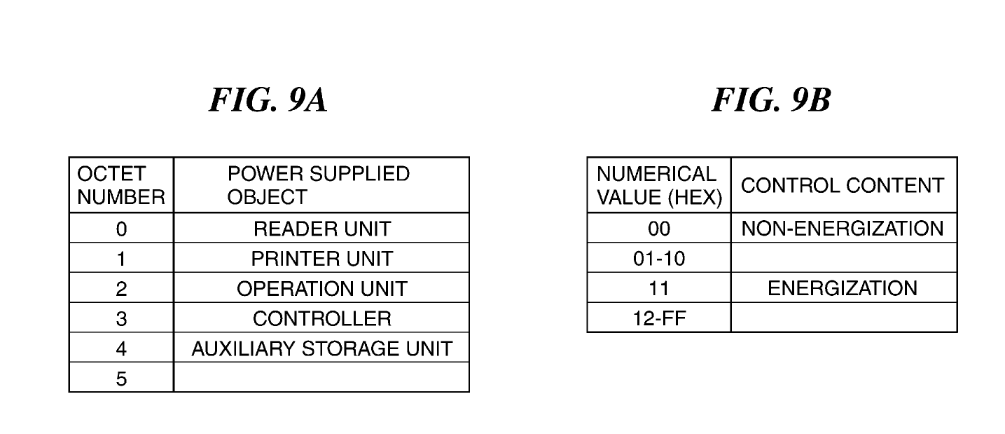

FIG. 9A shows a controlled object table that indicates a correspondence relation between octet numbers representing orders of octets in a 6-octet power control parameter contained in the payload of the magic packet of FIG. 8B and power supplied objects of the image forming apparatus. FIG. 9B shows a control content table that indicates a correspondence relation between numerical values of octets in the 6-octet power control parameter contained in the payload of the magic packet of FIG. 8B and contents of power supply control.

The controlled object table of FIG. 9A has an octet number field and a power controlled object field. In the octet number field, there are indicated octet numbers “0” to “5” that represent orders of octets, counted from the top octet, in the 6-octet power control parameter 00:00:00:11:11:00 contained in the payload of FIG. 8B. In the power controlled object field, there are indicated power supplied objects of the image forming apparatus 1 (reader unit, printer unit, operation unit, controller, and auxiliary storage unit in the illustrated example) so as to respectively correspond to the octet numbers “0” to “4”. The power controlled object field corresponding to the octet number “5” is left blank for future use.

The control content table of FIG. 9B includes a numerical value field and a control content field. In the numerical value field, there are indicated numerical values (in hexadecimal) of octets in the power control parameter (6-octet parameter 00:00:00:11:11:00 in the example of FIG. 8B) contained in the payload of the magic packet to be used as data. In the control content field, there are indicated contents of control (energization and non-energization in the example of FIG. 9B) corresponding to numerical values “00” and “11”, respectively. Control content fields respectively corresponding to numerical values “01” to “10” and “12” to “FF” are left blank for future use.

In a case that the controlled object table of FIG. 9A and the control content table of FIG. 9B are set as illustrated and the payload of the magic packet used as data for the image forming apparatus 1 contains the 6-octet power control parameter 00:00:00:11:11:00 as shown in FIG. 8B, power supplies to the reader unit 2, printer unit 4, and operation unit 5 remain off, but power supplies to the controller 3 and auxiliary storage unit 6 are turned on at startup of the image forming apparatus 1.

It should be noted that a power controlled object corresponding to the sixth octet (represented by octet number 5) in the power control parameter is left blank for future use. Thus, even if the numerical value of the sixth octet is “11” that represents energization of a corresponding power controlled object, no power is supplied to the undefined power controlled object.

As described above, based on the power controlled objects set in the controlled object table and the contents of control set in the control content table, it is possible to carry out optimum power control according to the data at startup of the image forming apparatus 1 (upon transition of the operation state of the apparatus).

It should be noted that setting items and setting contents in the controlled object table and in the control content table are not limited to those shown in FIGS. 9A and 9B. In a case, for example, that it is preferable to start printing immediately after power is remotely turned on, the 6-octet power control parameter contained in the payload of the magic packet, the controlled object table of FIG. 9A, and the control content table of FIG. 9B can be configured such that the image forming apparatus 1 transits from the power-off state 420 to e.g. the normal state 410 in response to remote power-on.

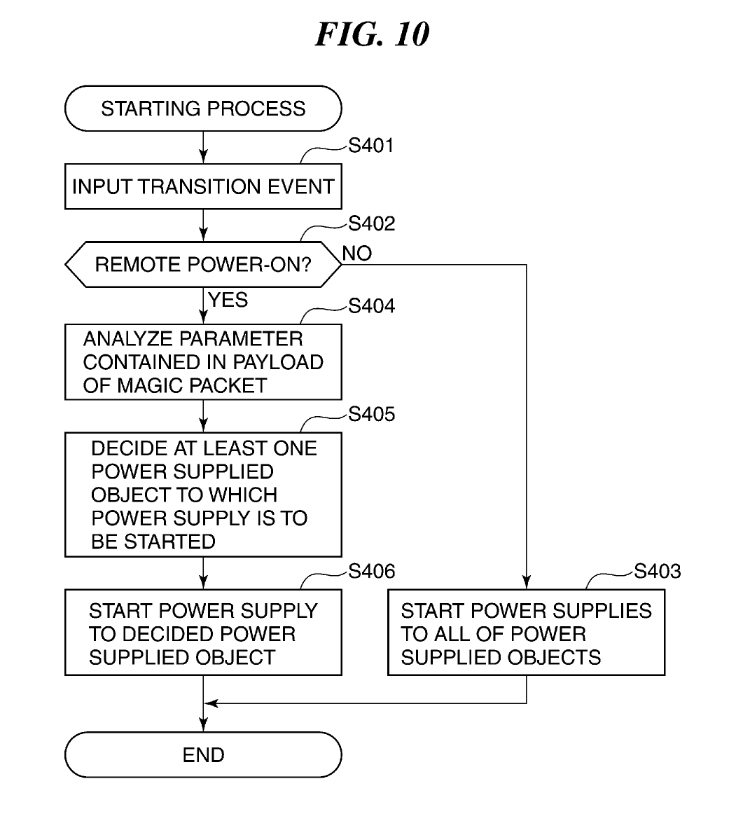

FIG. 10 shows in flowchart the procedures of a starting process performed by the CPU 201 of the main board 200 of the controller 3.

It is assumed here that the image forming apparatus 1 is in a power-off state where reduced power is supplied to the LAN interface 208 that performs network processing.

In the starting process of FIG. 10, the CPU 201 of the image forming apparatus 1 inputs a transition event that has occurred in the image forming apparatus 1 (step S401). Next, the CPU 201 determines whether or not the transition event input in step S401 is remote power-on, i.e., reception of a magic packet from the computer 9 via the LAN (step S402).

If determined that the transition event input in step S401 is e.g. a user's power-on operation and is not remote power-on (NO to step S402), power supplies to all of the power supplied objects of the image forming apparatus 1 are started (step S403), whereupon the present process is completed. In that case, the image forming apparatus 1 transits from the power-off state 420 to the normal state 410.

When a magic packet (data) from the computer 9 arrives at the LAN interface 208 via the LAN 10 at start of the starting process of FIG. 10, the CPU 201 receives the magic packet in step S401. In that case, step S401 achieves a function of a reception unit of this invention that receives data from an external apparatus via a network.

If determined that the transition event input in step S401 is remote power-on (YES to step S402), the CPU 201 analyzes a 6-octet power control parameter contained in the payload of the magic packet received in step S401, referring to the controlled object table of FIG. 9A and the control content table of FIG. 9B (step S404).

Based on a result of the analysis in step S404 on the power control parameter contained in the magic packet (i.e., the predetermined correspondence relation among octet values in the power control parameter, power supplied objects, and content of power supply control), the CPU 201 decides at least one power supplied object, among the power supplied objects of the image forming apparatus 1, to which power supply is to be started at startup of the image forming apparatus (upon transition of apparatus operation state) (step S405).

Then, the CPU 201 controls the power unit 7 such that power supply to the at least one power supplied object decided in step S405 is started (step S406), whereupon the present process is completed.

In that case, the image forming apparatus 1 transits from the power-off state 420 to the partially activated state 440 where power supplies to the reader unit 2, printer unit 4, and operation unit 5 remain off, whereby power saving can be achieved. Even if power supplies to the reader unit 2, printer unit 4, and operation unit 5 remain off, the usability is less likely to be impaired since the user is not near the image forming apparatus 1 in most cases when power is turned on by remote.

Step S405 achieves a function of a decision unit of this invention that decides based on data received by a reception unit at least one power supplied object, among a plurality of power supplied objects, to which power supply is to be started at startup of the image forming apparatus. Step S406 achieves a function of a control unit of this invention that controls a power unit such that power supply to the at least power supplied object decided by the decision unit is started at startup of the image forming apparatus.

As described above, according to this embodiment, it is possible to transit the image forming apparatus 1 from the power-off state to the partially activated state 440 in response to reception of a magic packet, whereby appropriate power control can be carried out at startup of the image forming apparatus 1 (upon transition of the operation state of the apparatus).

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-230945, filed Oct. 18, 2012, which is hereby incorporated by reference herein in its entirety.

1. An image forming apparatus including a plurality of power supplied objects and being communicatable with an external apparatus, comprising:
a reception unit configured to receive, from the external apparatus, data that indicates power supply control to be performed on the plurality of power supplied objects at startup of the image forming apparatus;
a decision unit configured, based on the data received by said reception unit, to decide power supplied object, among the plurality of power supplied objects, to which power supply is to be started at startup of the image forming apparatus; and
a control unit configured to control such that power supply to the power supplied object decided by said decision unit is started at startup of the image forming apparatus.

2. The image forming apparatus according to claim 1, wherein said, control unit controls such that power supply to each of power supplied objects, other than the power supplied object decided by said decision unit, is not started at startup of the image forming apparatus.

3. The image forming apparatus according to claim 2, wherein the data is a magic packet having a payload that includes a power control parameter including a plurality of octet values, and
said decision unit decides the power supplied object based on a predetermined correspondence relation among the plurality of octet values in the power control parameter, the plurality of power supplied objects, and the content of power supply control.

4. The image forming apparatus according to claim 1, wherein an operation state of the image forming apparatus transits among a normal state where power is supplied to all of the plurality of power supplied objects, a power saving state where power consumption in the image forming apparatus is reduced, a power-off state where power supplies to all of the plurality of power supplied objects are shut off, and a partially activated state where power supplies to part of the plurality of power supplied objects are shut off.

5. The image forming apparatus according to claim 4, wherein the image forming apparatus transits from the power-off state to the partially activated state when remote power-on is performed over the network based on the data.

6. A control method for an image forming apparatus including a plurality of power supplied objects and being communicatable with an external apparatus via a network, comprising:
a reception step of receiving, from the external apparatus, data that indicates power supply control to be performed on the plurality of power supplied objects at startup of the image forming apparatus;
a decision step, based on the data received in said reception step, of deciding power supplied object, among the plurality of power supplied objects, to which power supply is to be started at startup of the image forming apparatus; and
a control step of controlling such that power supply to the power supplied object decided in said decision step is started at startup of the image forming apparatus.

7. A non-transitory computer-readable storage medium storing a program for causing a computer to execute a control method for an image forming apparatus including a plurality of power supplied objects and being communicatable with an external apparatus via a network, the control method comprising:
a reception step of receiving, from the external apparatus, data that indicates power supply control to be performed on the plurality of power supplied objects at startup of the image forming apparatus;
a decision step, based on the data received in said reception step, of deciding power supplied object, among the plurality of power supplied objects, to which power supply is to be started at startup of the image forming apparatus; and
a control step of controlling such that power supply to the power supplied object decided in said decision step is started at startup of the image forming apparatus.
